(19) United States
(12) Patent Application Publication
(10) Pub. No.: US 2013/0159415 A1
(43) Pub. Date: Jun. 20, 2013

(54) CONGESTION CONTROL SYSTEM, CONGESTION CONTROL METHOD, AND COMMUNICATION UNIT

(71) Applicants: Satoshi Kamiya, Tokyo (JP); Miki Yamamoto, Osaka (JP)

(72) Inventors: Satoshi Kamiya, Tokyo (JP); Miki Yamamoto, Osaka (JP)

(73) Assignee: KANSAI UNIVERSITY, Suita-shi, Osaka (JP)

(21) Appl. No.: 13/702,568

(22) PCT Filed: Jun. 2, 2011
(86) PCT No.: PCT/JP2011/062712

§ 371 Date: Feb. 8, 2013

(30) Foreign Application Priority Data
Jun. 7, 2010 (JP) 2010-130480

(51) Int. Cl. H04L 12/56

(52) U.S. Cl. CPC H04L 47/11
USPC 709/204

(57) ABSTRACT

A congestion control system is provided with a plurality of reaction points, each of which is configured to transmit a packet to a transmission destination; and a congestion point configured to receive the packets transmitted from the plurality of reaction points. When detecting congestion in itself, the congestion point samples each of the received packets based on a predetermined algorithm, and transmits a feedback message to the reaction point as a transmission source of the sampled packet. Each of the plurality of reaction points controls a target rate based on a reception situation of the feedback message, and sets the target rate to an initial value at an initialization timing which does not depend on the feedback message.

### TECHNICAL FIELD

The present invention is related to a congestion control technique. More particularly, the present invention is related to a congestion control technique of a congestion notice (CN) method.

### RELATED ART

In recent years, the use of a data center is expanding in which servers are concentrated in one base station to provide computer resources to individuals and enterprises. In the data center, a network is required to have flexibility and expandability, by connecting a great deal of servers while securing high-speed processing, low delay, and a low discard rate.

In IEEE802.1, the technique, “data center bridging (DCB)” is set to extend a conventional MAC bridge function while satisfying the above requirement. As one elemental technique, a “congestion notice (CN)” is being standardized in IEEE802.1Qau. For the details of IEEE802.1Qau, refer to Non-Patent Literature 1.

In IEEE802.1Qau, a transmission source (a transmission point) of a packet is called a “reaction point (RP)”. The reaction point is typically contained in a transmitting section of a terminal which connected with the network. It should be noted that in IEEE802.1Qau, the transmitting section of the terminal is permitted to have a plurality of reaction points. On the other hand, a point where congestion occurs is called a “congestion point (CP)”. The congestion point is typically contained in a switch on the network. In this specification, these words of “reaction point” and “congestion point” are used.

As a kind of the congestion notice, “Quantized Congestion Notification (QCN)” is known. For example, for the details of QCN, refer to Non-Patent Literature 2. Hereinafter, the outline of QCN will be described with reference to FIG. 1 and FIG. 2.

A plurality of reaction points (RP) are connected with a congestion point (CP) in FIG. 1. Each of the plurality of reaction points transmits a packet PKT for a transmission destination. The congestion point receives the packets PKT transmitted from the plurality of reaction points. In other words, in FIG. 1, a flow from each of the plurality of reaction points passes through a common congestion point.

The congestion point has a congestion detection and notice function, and when detecting congestion at itself, notifies it to the reaction point. In detail, the congestion point monitors a queue length of an output queue for the transmission destination. When the queue length exceeds a predetermined threshold value, the congestion point determines that congestion has occurred. In this case, the congestion point carries out sampling of the reception packet and sends a “feedback message FB” to the transmission source (RP) of the sampled packet. Here, to reduce the overhead which accompanies the feedback message FB, the packet sampling is carried out stochastically (for example, once per 100 packets). That is, the congestion point transmits the feedback message FB only to the transmission source (RP) selected stochastically. The feedback message FB contains data indicating a degree of congestion at the congestion point. It should be noted that the degree of congestion is quantized and is inserted in the feedback message FB as 6-bit data.

The reaction point which is the packet transmission end controls a transmission rate based on the feedback message FB. Here, regarding the transmission rate of the reaction point, two control parameters: there are a “current rate CR” and a “target rate TR”. The current rate CR is a current transmission rate of the reaction point. The target rate TR is a target value of the current rate CR. Referring to FIG. 2, the basic function of the reaction point in QCN will be described.

First, the reaction point decreases the current rate CR in response to the reception of the feedback message FB. The decrease rate depends on the degree of congestion indicated by the feedback message FB. At the same time, the reaction point sets the target rate TR to the current rate CR immediately before the reception of the feedback message FB. In this way, the reaction point lowers the current rate CR and the target rate TR such that the congestion at the congestion point is eliminated when the feedback message FB is received.

A phase called “Fast Recovery” begins after the reception of the feedback message FB. In this phase, the reaction point increases the current rate CR while maintaining the target rate TR. In detail, the reaction point determines whether or not the feedback message FB is received during a predetermined period. The predetermined period is measured by using a timer or a byte counter. If not receiving any feedback message FB in the predetermined period, the reaction point increases the current rate CR. The reaction point executes such increase processing of the current rate CR a predetermined number of times (ex, five times) repeatedly. It should be noted that the reaction point performs the above-mentioned processing in response to the feedback message FB to reset the Fast Recovery phase, when receiving the feedback message FB in the Fast Recovery phase.

When the increase processing of the current rate CR is performed the predetermined number of times, that is, when the Fast Recovery phase ends, a phase called “Active Increase” begins. In this phase, the reaction point tries increase of the target rate TR and the current rate CR. In detail, the reaction point determines whether or not the feedback message FE is received in a predetermined period. The predetermined period is measured by using a timer or a byte counter. If not receiving any feedback message FB in the predetermined period, the reaction point increases the target rates TR a little bit. It is expected that the current rate CR, too, increases.

As described above, the reaction point changes the current rate CR and the target rate TR, when receiving the feedback message FB from the congestion point, or when confirming that the feedback message FB is not received in the predetermined period. This it, the reaction point controls the current rate CR and the target rate TR according to the reception situation of the feedback message FB from the congestion point. Thus, the elimination of congestion at the congestion point and the reservation of a transmission rate at the reaction point are expected.

### CITATION LIST

[Non-Patent Literature 1]: “IEEE P802.1Qau/D2.2,

Draft Standard for Local and Metropolitan Area Networks, Virtual Bridged Local Area Networks, Amendment: Congestion Notification”, (Jul. 23, 2009)
[Non-Patent Literature 2]: Mohammad Alizadeh et al., “Data Center Transport Mechanisms: Congestion Control Theory and IEEE Standardization”, (Proceedings of Forty-Sixth Annual Allerton Conference, UIUC, pp. 1270-1276, 2008)

### SUMMARY OF THE INVENTION

The inventor of the present invention paid attention on the following point. As shown in FIG. 1, when the feedback message FB is sent from the congestion point to the plurality of reaction points stochastically, there is a possibility that many feedback messages FB are sent only to a part of the reaction points. It is not desirable because it causes ununiformity of the transmission rates among the plurality of reaction points (a plurality of flows).

For example, FIG. 3 shows a time change of the transmission rate which was actually observed in the two reaction points (RP0, RP1) in case of QCN. As shown in FIG. 3, a total of transmission rates is stably controlled by QCN. However, it would be understood that the ununiformity of the transmission rate occurs between the two reaction points. In detail, each transmission rate reaches a stable state (a steady state) after passing through a transient state. In the stable state, the transmission rate repeats fine fluctuation, but does not change greatly and maintains an approximately constant value. This it, if the two reaction points have been stabilized once in the different transmission rate, then the ununiformity of the transmission rates continues.

It is desirable to suppress the ununiformity of the transmission rates among the plurality of reaction points as far as possible, regardless of QCN.

One subject matter of the present invention is to provide a congestion control technique which can restrain the ununiformity of transmission rates among a plurality of reaction points.

In one aspect of the present invention, a congestion control system is provided. The congestion control system is provided with: a plurality of reaction points, each of which is configured to transmit a packet to a transmission destination; and a congestion point configured to receive the packets transmitted from the plurality of reaction points. When detecting congestion in itself, said congestion point samples each of the received packets based on a predetermined algorithm, and transmits a feedback message to the reaction point as a transmission source of the sampled packet. Each of the plurality of reaction points controls a target rate based on a reception situation of the feedback message, and sets the target rate to an initial value at an initialization timing which does not depend on the feedback message.

In another aspect of the present invention, a communication unit is provided. The communication unit includes at least one reaction point configured to transmit a packet to a transmission destination and to control a target rate based on a reception situation of a feedback message. When the congestion point which receives a packet transmitted from the reaction point detects congestion in itself and samples the received packet based on a predetermined algorithm, the feedback message is transmitted to the reaction point as a transmission source of the sampled packet. The reaction point sets the target rate to an initial value at an initialization timing which does not depend on the feedback message.

In another aspect of the present invention, a congestion control method is provided. The congestion control method includes: (A) sampling a received packet based on a predetermined algorithm and transmitting a feedback message to a transmission source of the packet, when detecting congestion; (B) controlling a target rate based on a reception situation of the feedback message; and (C) setting the target rate to an initial value at an initialization timing which does not depend on the feedback message.

According to the present invention The partiality of the transmission rate among the plurality of reaction points becomes able to be restrained in case of control of being congestion which is based on the method of the congestion notice.

### BRIEF DESCRIPTION OF THE DRAWINGS

The above and other objects, the advantage, and the features would become clear from the exemplary embodiments of the present invention described with reference to the following drawings:

FIG. 1 is a schematic diagram showing QCN (Quantized Congestion Notification);

FIG. 2 is a diagram showing a typical function of a reaction point in QCN;

FIG. 3 is a graph showing the ununiformity of a transmission rate among a plurality of reaction points;

FIG. 4 is a schematic diagram showing a configuration of a congestion control system according to an exemplary embodiment of the present invention;

FIG. 5 is a diagram showing a TR initialization function of a reaction point (a communication unit) according to the exemplary embodiment of the present invention;

FIG. 6A is a diagram showing the effect which is attained by the exemplary embodiment of the present invention;

FIG. 6B is a diagram showing the effect which is attained by the exemplary embodiment of the present invention;

FIG. 7 is a block diagram showing a configuration example of the reaction point according to the exemplary embodiment of the present invention;

FIG. 8 is a flow chart showing an operation of the reaction point according to the exemplary embodiment of the present invention;

FIG. 9 is a conceptual diagram showing an example of the initialization timing in the exemplary embodiment of the present invention;

FIG. 10 is a conceptual diagram showing another example of the initialization timing in the exemplary embodiment of the present invention;

FIG. 11 is a conceptual diagram showing an example of an initialization period in the exemplary embodiment of the present invention;

FIG. 12 is a block diagram showing a configuration example of an initialization control section according to the exemplary embodiment of the present invention;

FIG. 13 is a block diagram showing a first configuration example of the congestion control system according to the exemplary embodiment of the present invention;

FIG. 14 is a block diagram showing a second configuration example of the congestion control system according to the exemplary embodiment of the present invention; and

FIG. 15 is a block diagram showing a third configuration example of the congestion control system according to the exemplary embodiment of the present invention.

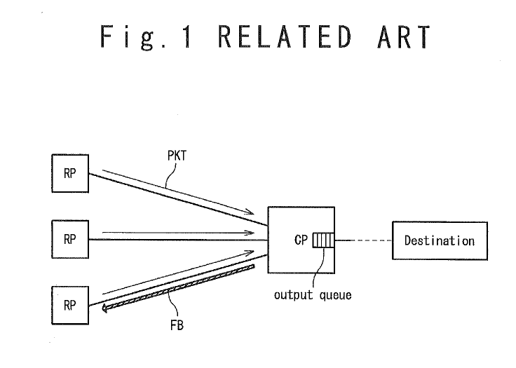

### DESCRIPTION OF EXEMPLARY EMBODIMENTS

Hereinafter, the exemplary embodiment of the present invention will be described with reference to the attached drawings.

### 1. OUTLINE

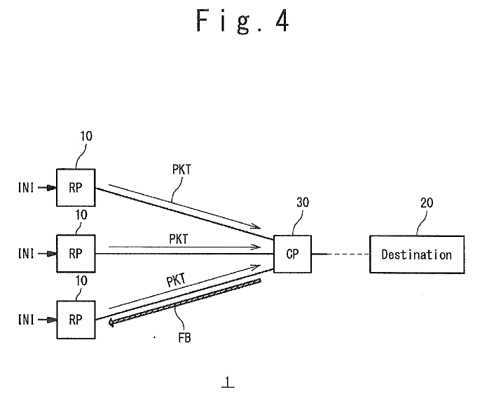

FIG. 4 is a schematic diagram showing a configuration of a congestion control system 1 according to a present exemplary embodiment. The congestion control system 1 is provided with a plurality of reaction points (RP) 10, a transmission destination 20 and a congestion point (CP) 30.

The reaction point 10 is typically contained in a transmitting section of a terminal which is connected with a network. It should be noted that it is allowed in IEEE802.1Qau that a transmitting section of one terminal is provided with a plurality of the reaction points 10. The transmission destination 20 is a terminal typically. The reaction points 10 and the transmission destination 20 are connected with the network. Each of the plurality of reaction points 10 transmits a packet PKT to the transmission destination 20.

The congestion point 30 is arranged on the network between the reaction point 10 and the transmission destination 20. The congestion point 30 is typically contained in a switch. In FIG. 4, the congestion point 30 is connected with the plurality of reaction points 10 and receives the packets PKT transmitted from the plurality of reaction points 10. In other words, a flow from each of the plurality of reaction points 10 passes through a common congestion point 30.

The congestion point 30 has a function of detection and notice of congestion. This is, when detecting congestion in itself, the congestion point 30 samples the received packet PKT according to a predetermined algorithm and transmits a feedback message FB to the reaction point 10 as a transmission source of the sampled packet PKT.

As an example, a case of QCN will be considered. The congestion point 30 monitors the queue length of an output queue for the transmission destination 20. When the queue length exceeds a predetermined threshold value, the congestion point 30 determines that congestion has occurred. In this case, the congestion point 30 carries out the sampling of the received packet PKT and sends the feedback message FE to the reaction point 10 as the transmission source of the sampled packet PKT. Here, in order to reduce the overhead which accompanies the feedback message FB, the packet sampling is carried out stochastically (for example, once per 100 packets). That is, the congestion point 30 transmits the feedback message FB only to the transmission source (RP) selected stochastically. The feedback message FB contains data showing a degree of congestion in the congestion point 30. It should be noted that the degree of congestion is quantized and is inserted in the feedback message FB as 6-bit data.

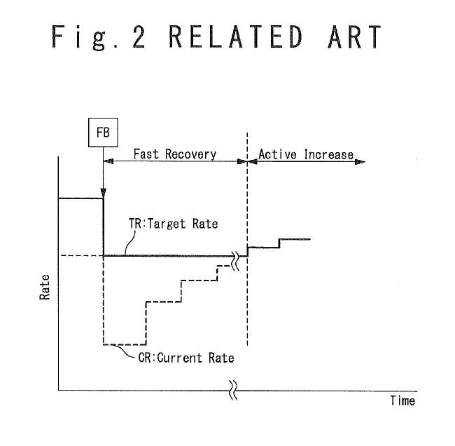

The reaction point 10 as a packet transmission end controls a transmission rate based on the feedback message FB as shown in FIG. 2. That is, the reaction point 10 decreases a current rate CR in response to the reception of the feedback message FB. A decrease rate depends on the degree of congestion indicated by the feedback message FB. At the same time, the reaction point 10 sets a target rate TR to the current rate CR immediately before the reception of the feedback message FB.

Also, in a Fast Recovery phase and an Active Increase phase, the reaction point 10 determines whether or not it has received the feedback message FB in a predetermined period. The predetermined period is measured by using a timer or a byte counter. If not receiving one feedback message FB in the predetermined period, the reaction point 10 increases the current rate CR and the target rate TR according to the necessity.

In this way, the reaction point 10 changes the current rate CR and the target rate TR (refer to FIG. 2), when the reaction point 10 receives the feedback message FB from the congestion point 30, or when it is confirmed that the feedback message FB is not received in the predetermined period. This it, the reaction point 10 controls the current rate CR and the target rate TR according to the reception situation of the feedback message FB from the congestion point 30.

Moreover, the reaction point 10 according to the present exemplary embodiment has the following function additionally. This it, the reaction point 10 initializes the target rate TR compulsorily, regardless of the reception situation of the feedback message FB during an ordinary operation. In other words, the reaction point 10 initializes the target rate TR compulsorily at the timing which does not depend on the feedback message FB during the ordinary operation. Such processing is hereinafter called the “TR initialization processing”. Also, the timing of the TR initialization processing is hereinafter called the “initialization timing”.

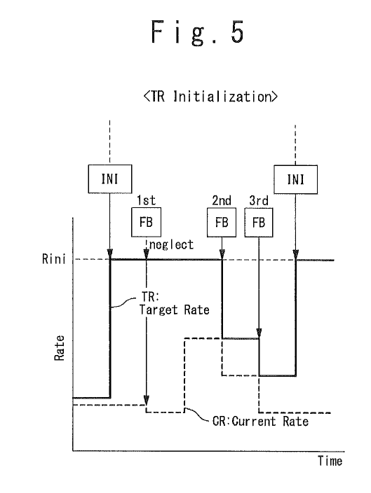

FIG. 5 is a conceptual diagram showing the TR initialization processing according to the present exemplary embodiment. At the initialization timing which does not depend on the feedback message FB during the ordinary operation, an initialization signal INI is supplied to the reaction point 10. In response to this initialization signal INI, the reaction point 10 sets the target rate TR to an initial value Rini. It is desirable that the initial value Rini is sufficiently large. For example, as the initial value Rini is a maximum transmission rate at which the reaction point 10 is operable, i.e. a physical link rate.

Also, the reaction point 10 ignores the processing of the target rate TR based on the feedback message FB(1st) received first after a timing (initialization timing) of TR initialization processing. In other words, the reaction point 10 prohibits the control of the target rate TR in response to the feedback message FB (1st). Thus, the decrease of the target rate TR is restrained, and it is expected that the current rate CR increases. In response to reception of the second feedback message FB (2nd) and the subsequent FB (3rd), the reaction point 10 carries out control processing of the target rate TR and the current rate CR. In other words, the reaction point 10 performs the control of the target rate TR and the current rate CR in response to the feedback messages FB (2nd) and FB (3rd).

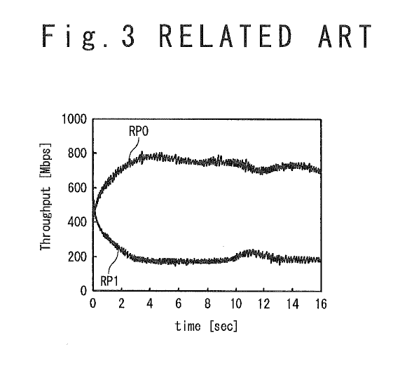

The effect of the TR initialization processing is as follows. As shown in FIG. 3, the plurality of reaction points conventionally tended to be stable at the transmission rates which are different from each other. In the stable state, the transmission rate repeats minute fluctuation but does not change largely, and is maintained to an approximately predetermined value. In other words, if once stabilized, the transmission rate lost a trigger of the rise. According to the present exemplary embodiment, in the TR initialization processing, the target rate TR of the reaction point 10 is compulsorily initialized sometimes. In other words, the TR initialization processing compulsorily makes the reaction point 10 shift to a transient state before the transmission rate is stabilized. This means giving a chance of changing the transmission rate to the reaction point 10. Thus, it is expected that the transmission rate set to a low value rises.

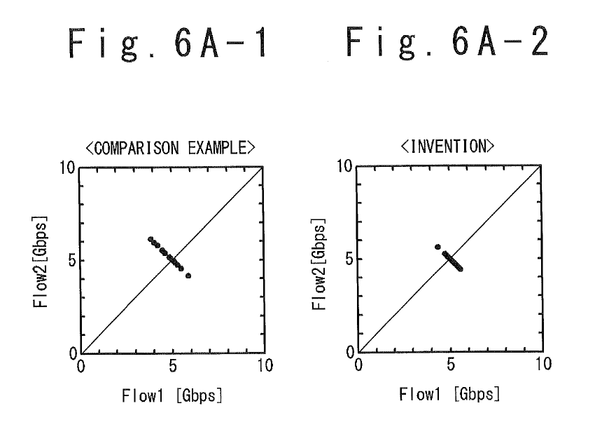

FIG. 6A shows distributions of transmission rate in two flows (reaction points) for a comparison example and the present exemplary embodiment. In the comparison example, only the rate control processing shown in FIG. 2 is executed, and the TR initialization processing according to the present exemplary embodiment is not executed. In graphs of FIG. 6A, the horizontal axis shows a transmission rate in one of the two flows (Flow1), the vertical axis shows a transmission rate in the other flow (Flow2). Each point shows the transmission rate in the stable state. The concentration of points to the center of the graph means that a rate allocation is fairly accomplished. It could be seen that the transmission rate is varied between the two flows in case of the comparison example, and the variation is suppressed in the present exemplary embodiment. That is, according to the present exemplary embodiment, a variation of transmission rates between the plurality of reaction points 10 is restrained. In the same way, FIG. 6B shows the distributions of the transmission rate of four flows (reaction points) in the comparison example and the present exemplary embodiment. Like FIG. 6A, it could be seen that the transmission rates are varied among the flows in case of the comparison example, and the variation is suppressed in the present exemplary embodiment. That is, according to the present exemplary embodiment, the variation of transmission rates among the plurality of reaction points 10 is restrained.

### 2. EXAMPLE OF THE REACTION POINT

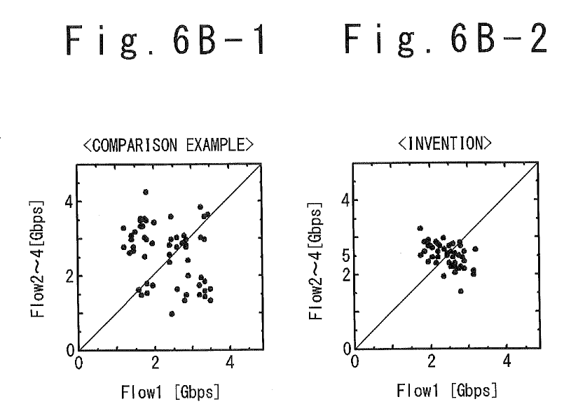

FIG. 7 is a block diagram showing a configuration example of the reaction point 10 according to the present exemplary embodiment. The reaction point 10 is provided with a rate limiter 11, a rate calculator 12, a timer 13 and a byte counter 14.

The rate limiter 11 receives a packet PKT from an upper layer and sends out a packet PKT to a lower layer. Also, the rate limiter 11 sets the transmission rate to the current rate CR in response to an instruction from the rate calculator 12.

The rate calculator 12 maintains control parameters such as the target rate TR and the current rate CR. Then, the rate calculator 12 determines the target rate TR and the current rate CR according to the reception situation of the feedback message FB from the congestion point 30 (reference to FIG. 2). The rate calculator 12 notifies the determined current rate CR to the rate limiter 11.

Moreover, the rate calculator 12 executes the above-mentioned TR initialization processing in response to the initialization signal INI (reference to FIG. 5). Therefore, the rate calculator 12 may maintain the initial value Rini of the reaction point 10 as an initialization object. Or, the initial value Rini may be contained in the initialization signal INI. In any case, the rate calculator 12 sets the target rate TR to the initial value Rini in response to the initialization signal INI which does not depend on the feedback message FB.

In the Fast Recovery phase and the Active Increase phase, a predetermined period needs to be measured. The predetermined period can be measured by using the timer 13 or the byte counter 14. The byte counter 14 monitors the packet PKT which is transmitted from the rate limiter 11 and increases a count value every time the packet PKT of the predetermined number of bytes is transmitted. A period until the count value reaches a predetermined value or a predetermined time period elapsed in the timer 13 is used as a measurement value of the predetermined period.

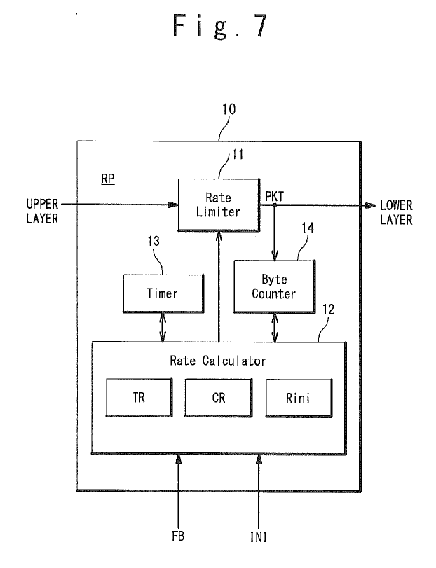

FIG. 8 is a flow chart showing an operation of the reaction point 10 according to the present exemplary embodiment. The reaction point 10 controls the target rate TR and the current rate CR according to the reception situation of the feedback message FB and the reception situation of the initialization signal INI, as shown in FIG. 2, (Step S10).

The reaction point 10 receives the initialization signal INI at the initialization timing which does not depend on the feedback message FB (Step S11: Yes). The reaction point 10 executes the TR initialization processing in response to the initialization signal INI and as shown in FIG. 5 (Step S12). When receiving the feedback message FB (Step S13: Yes), the reaction point 10 checks whether or not this feedback message FB is the first signal after the reception of the initialization signal INI (Step S14). When the feedback message FB is the first signal after the reception of the initialization signal INI (Step S14: Yes), the reaction point 10 skips substitution processing (step S15) of the current rate CR into the target rate TR. Moreover, the reaction point 10 updates the current rate CR based on the feedback message FB (Step S16). Thus, the decrease of the target rate TR is restrained.

It should be noted that the above processing by the reaction point 10 is typically realized by executing the “communication unit control program” by the communication unit (a computer) on which the reaction point 10 is mounted. The communication unit control program is a computer program to make the communication unit (computer) execute the above processing. The communication unit control program may be recorded in a computer-readable storage medium.

### 3. INITIALIZATION TIMING

In each reaction point 10, the TR initialization processing is repeatedly executed. Here, it is desirable that the TR initialization processing in each reaction point 10 is not synchronous with each other. That is, it is ideal that the initialization timings are different among the plurality of reaction points 10 (a plurality of flows). Thus, the ununiformity of transmission rates among the plurality of reaction points 10 is more effectively restrained.

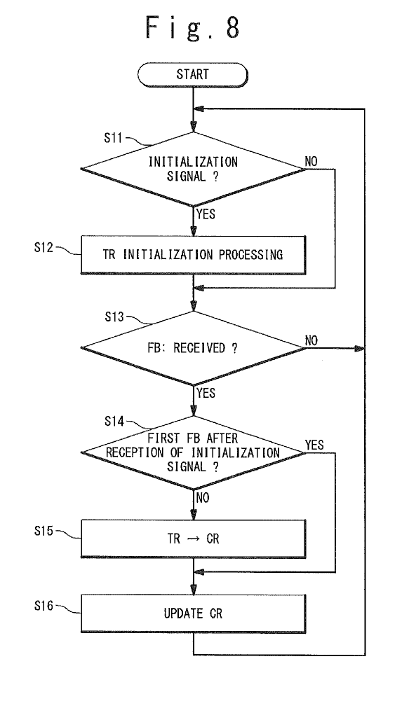

FIG. 9 shows an example of setting the initialization timings. In an example of FIG. 9, both of the initialization timings and an initialization interval (an interval between two continuous initialization timings) are different among the plurality of reaction points 10. In more detail, the initialization interval of the reaction point RP1 is set as T1, and the initialization interval of the reaction point RP2 is set as T2 which is longer than T1. Moreover, the initialization timings are varied between the reaction points RP1 and RP2.

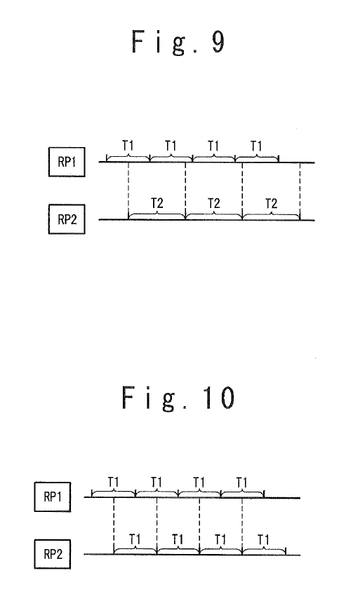

FIG. 10 shows another example of setting the initialization timings. In the example of FIG. 10, the initialization intervals are same but the initialization timings are different between the reaction points RP1 and RP2.

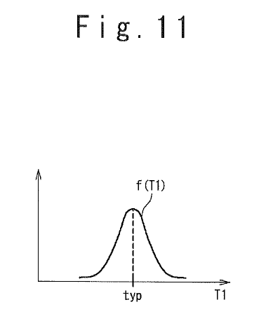

Moreover, regarding each reaction point 10, the initialization interval is not necessary to be fixed and it may be changed dynamically. In other words, the initialization interval may be set to be variable. For example, as for each reaction point 10, the initialization interval may be set to be “random”. Also, as shown in FIG. 11, the initialization interval may have a probability distribution. In an example of FIG. 11, the initialization interval is deviated around an average typ. Even in such setting, the initialization timings are deviated among the plurality of reaction points 10, and that is desirable.

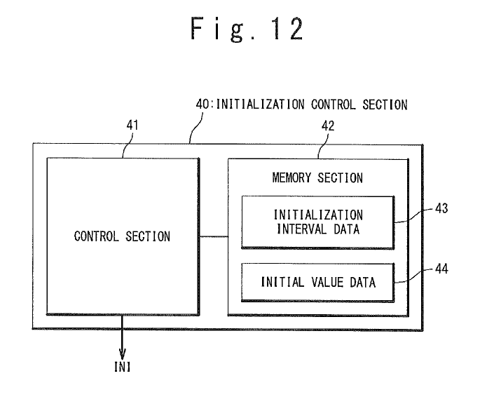

It is the initialization control section 40 that manages or controls such initialization timings. FIG. 12 is a block diagram showing a configuration example of the initialization control section 40. The initialization control section 40 is provided with a control section 41 and a memory section 42. Initialization interval data 43 and initial value data 44 are stored in the memory section 42. The initialization interval data 43 indicates the initialization interval of each of the reaction points 10 managed by the initialization control section 40. The initial value data 44 indicates the initial value Rini of each of the reaction points 10 managed by the initialization control section 40. But, when each reaction point 10 maintains and manages the initial value Rini, the initial value data 44 is unnecessary. Referring to the initialization interval data 43, the control section 40 generates the initialization signal INI at each initialization timing and transmits the initialization signal INI to the corresponding reaction point 10.

As for a relation of the plurality of reaction points 10 and the initialization control section 40, various forms are thought of. Hereinafter, various configuration examples will be described.

### 4. VARIOUS CONFIGURATION EXAMPLES

### 4-1. First Configuration Example

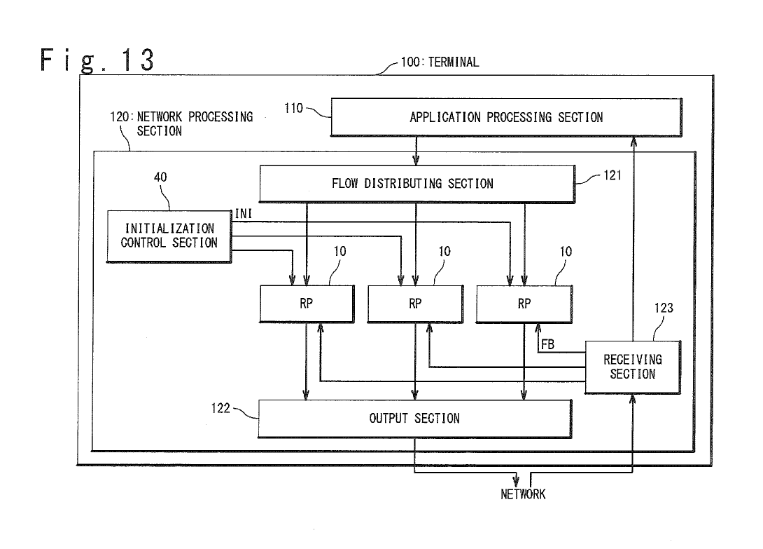

FIG. 13 is a block diagram showing a first configuration example. In this configuration example, one terminal 100 (communication unit) is provided with the plurality of reaction points 10 and the initialization control section 40. The initialization control section 40 is configured in common to the plurality of reaction points 10. In this case, the initialization control section 40 manages the initialization timing of each reaction point 10 in concentration, to transmit the initialization signal INI to each reaction point 10 at each initialization timing.

In more detail, the terminal 100 is provided with an application processing section 110 which executes application processing, and a network processing section 120 which executes network processing. The application processing section 110 takes charge of the processing of an upper layer and contains a CPU and an OS. As the network processing section 120, a network Interface Card (NIC) is exemplified.

The network processing section 120 is provided with a plurality of reaction points 10, the initialization control section 40, a flow distributing section 121, an output section 122 and a receiving section 123. The receiving section 123 receives multiplexed data from the network and the multiplexed data is demultiplexed. Then, the receiving section 123 forwards the data packets PKT to the application processing section 110 and also forwards the feedback message FB to a specified reaction point 10.

The flow distributing section 121 receives the data packets PKT from the application processing section 110. Then, the flow distributing section 121 distributes the transmitted packets PKT to any of the plurality of reaction points 10. As mentioned above, each reaction point 10 controls a transmission rate based on the feedback message FB. Each reaction point 10 outputs the data packets PKT to the output section 122. The output section 122 multiplexes the data packets PKT and outputs the multiplexed data packet onto the network.

In such a network processing section 120, one initialization control section 40 is connected to the plurality of reaction points 10 in common. This common initialization control section 40 manages or controls the initialization timings of all the reaction point 10 intensively, and transmits the initialization signal INI to each of the reaction points 10 in the corresponding initialization timing. Each reaction point 10 executes the TR initialization processing in response to the initialization signal INI.

### 4-2. Second Configuration Example

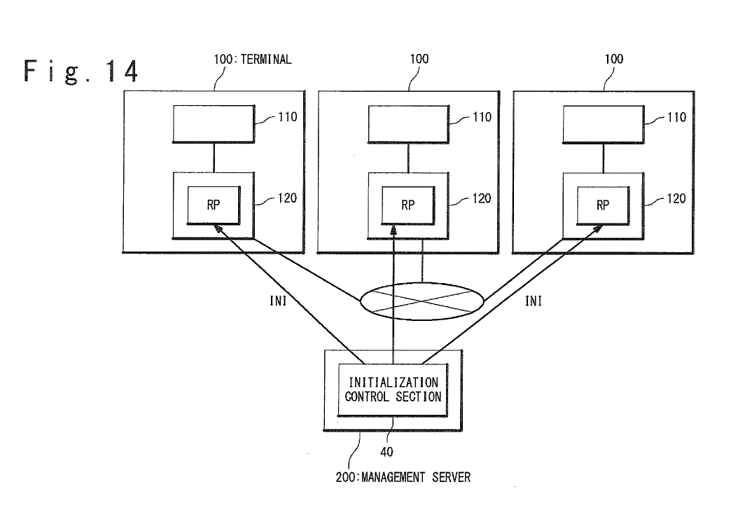

FIG. 14 is a block diagram showing a second configuration example. Like the above first configuration example, the initialization control section 40 is provided in common to the plurality of reaction points 10 in the present configuration example, too. However, the initialization control section 40 is provided for a management server 200 which is different from the terminal 100 (a communication unit) which has the reaction point 10.

As shown in FIG. 14, in more detail, the management server 200 is connected to the plurality of terminals 100 in common. Each terminal 100 (the communication unit) is provided with the above-mentioned application processing section 110 and the network processing section 120. The network processing section 120 is provided with at least one reaction point 10. The management server 200 is provided with the initialization control section 40. The initialization control section 40 controls the initialization timing of the reaction point 10 of each of the plurality of terminals 100 intensively, and transmits the initialization signal INI to each reaction point 10 at the corresponding initialization timing. Each reaction point 10 executes the TR initialization processing in response to the initialization signal INI.

### 4-3. Third Configuration Example

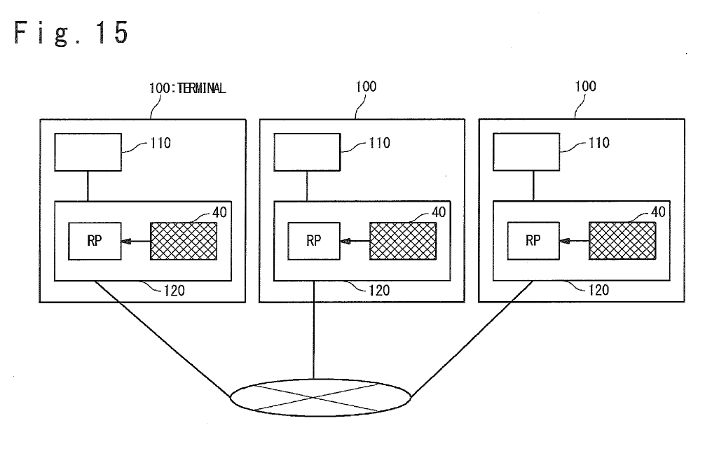

FIG. 15 is a block diagram showing a third configuration example. In the third configuration example, the initialization control section 40 is provided for every reaction point 10. Each initialization control section 40 controls the initialization timing of one corresponding reaction point 10, and transmits the initialization signal INI to the corresponding reaction point 10 in the corresponding initialization timing.

As shown in FIG. 15, in more detail, the plurality of terminals 100 are connected with the network. Each terminal 100 (communication unit) is provided with the above-mentioned application processing section 110 and the network processing section 120. The network processing section 120 is provided with the reaction point 10 and the initialization control section 40 which controls and manages the reaction point 10. The initialization control section 40 transmits the initialization signal INI to the reaction point 10 at the specified initialization timing. The reaction point 10 executes the TR initialization processing in response to the initialization signal INI.

In above, the exemplary embodiments of the present invention have been described with reference to the attached drawings. However, the present invention is not limited to the above-mentioned exemplary embodiments and can be appropriately changed by a person in the art in a range which does not depart from the present invention.

A part or all of the above-mentioned exemplary embodiments can be mentioned as in the following addition items, but are not limited below.

### (Addition Item 1)

A congestion control system is provided with:

a plurality of reaction points, each of which is configured to transmit a packet to a transmission destination; and

a congestion point configured to receive the packets transmitted from the plurality of reaction points,

wherein when detecting congestion in itself, said congestion point samples each of the received packets based on a predetermined algorithm, and transmits a feedback message to the reaction point as a transmission source of the sampled packet, and

wherein each of the plurality of reaction points controls a target rate based on a reception situation of the feedback message, and sets the target rate to an initial value at an initialization timing which does not depend on the feedback message.

### (Addition Item 2)

The congestion control system according to addition item 1, wherein each of the reaction points prohibits the control of the target rate based on the feedback message received first after the initialization timing.

### (Addition Item 3)

The congestion control system according to addition item 1 or 2, wherein the initial value is a maximum transmission rate.

### (Addition Item 4)

The congestion control system according to any of addition items 1 to 3, wherein the initialization timing is different among the plurality of reaction points.

### (Addition Item 5)

The congestion control system according to any of addition items 1 to 4, wherein an interval between the initialization timings is different among the plurality of reaction points.

### (Addition Item 6)

The congestion control system according to any of addition items 1 to 5, wherein the interval of the initialization timings is not predetermined.

### (Addition Item 7)

The congestion control system according to any of addition items 1 to 6, further provided with:

an initialization control section configured to generate the initialization signal at the initialization timing,

wherein each reaction point sets the target rate to the initial value in response to the initialization signal.

### (Addition Item 8)

The congestion control system according to addition item 7, wherein the initialization control section is provided in common to the plurality of reaction points, and manages the initialization timing of each of the plurality of reaction points, and transmits the initialization signal to each reaction point at the initialization timing.

### (Addition Item 9)

The congestion control system according to addition item 7, wherein the initialization control section is provided for each of the plurality of reaction points, and manages the initialization timing of a corresponding one of the plurality of reaction points, and transmits the initialization signal to the one of the reaction points corresponding to the initialization timing.

### (Addition Item 10)

A communication unit is provided with:

at least one reaction point configured to transmit a packet to a transmission destination and to control a target rate based on a reception situation of a feedback message,

wherein when the congestion point which receives a packet transmitted from the reaction point detects congestion in itself and samples the received packet based on a predetermined algorithm, the feedback message is transmitted to the reaction point as a transmission source of the sampled packet, and

wherein the reaction point sets the target rate to an initial value at an initialization timing which does not depend on the feedback message.

### (Addition Item 10′)

A communication unit in a congestion control system, wherein the congestion control system is provided with:

a plurality of reaction points, each of which is configured to transmit a packet for a transmission destination; and

a congestion point configured to receive the packets transmitted from the plurality of reaction points,

wherein when detecting congestion in itself, the congestion point samples the received packet based on a predetermined algorithm, and transmits a feedback message to the reaction point as a transmission source of the sampled packet,

wherein the communication unit has at least one of the plurality of reaction points, and

wherein each of said plurality of reaction points controls a target rate based on a reception situation of the feedback message, and sets the target rate to an initial value at an initialization timing which does not depend on the feedback message.

### (Addition Item 11)

The congestion control method includes:

sampling a received packet based on a predetermined algorithm and transmitting a feedback message to a transmission source of the packet, when detecting congestion;

controlling a target rate based on a reception situation of the feedback message; and

setting the target rate to an initial value at an initialization timing which does not depend on the feedback message.

### (Addition Item 11′)

The congestion control method in a congestion control system, wherein the congestion control system includes:

a plurality of reaction points, each of which is configured to transmit a packet for a transmission destination; and

a congestion point configured to receive the packets transmitted from the plurality of reaction points,

wherein when detecting congestion in itself, the congestion point samples the received packet based on a predetermined algorithm, and transmits a feedback message to the reaction point as the transmission source of the sampled packet,

wherein the congestion control method includes:

controlling a target rate based on a reception situation of the feedback message in each of the plurality of reaction points; and

setting the target rate to an initial value at an initialization timing which does not depend on the feedback message in each of the plurality of reaction points.

### (Addition Item 12)

A communication control program making a computer of a communication unit which samples a received packet based on a predetermined algorithm, and transmits a feedback message to a transmission source of the sampled packet, when an external communication unit detecting congestion in itself, to function as:

transmitting means for transmitting the packet to the external communication unit;

control means for controlling a target rate based on a reception situation of the feedback message; and

initializing means for setting the target rate to an initial value at an initialization timing which does not depend on the feedback message.

The present application claims a priority based on Japanese Patent Application No. JP 2010-130480 filed on Jun. 7, 2010, and the disclosure thereof is incorporated herein by reference.

1. A congestion control system comprising:
a plurality of reaction points, each of which is configured to transmit a packet to a transmission destination;
a congestion point configured to receive the packets transmitted from said plurality of reaction points,
wherein when detecting congestion in itself, said congestion point samples each of the received packets based on a predetermined algorithm, and transmits a feedback message to one of said plurality of reaction points as a transmission source of the sampled packet, and
wherein each of said plurality of reaction points controls a target rate based on a reception situation of the feedback message, and sets the target rate to an initial value at an initialization timing which does not depend on the feedback message.

2. The congestion control system according to claim 1, wherein said reaction point prohibits the control of the target rate based on the feedback message received first after the initialization timing.

3. The congestion control system according to claim 1, wherein the initial value comprises a maximum transmission rate.

4. The congestion control system according to claim 1, wherein the initialization timing is different among said plurality of reaction points.

5. The congestion control system according to claim 1, wherein an interval between the initialization timings is different among said plurality of reaction points.

6. The congestion control system according to claim 1, wherein the interval of the initialization timings is not predetermined.

7. The congestion control system according to claim 1, further provided with:
an initialization control section configured to generate the initialization signal at the initialization timing,
wherein said reaction point sets the target rate to the initial value in response to the initialization signal.

8. The congestion control system according to claim 7, wherein said initialization control section is provided in common to said plurality of reaction points, and manages the initialization timing of each of said plurality of reaction points, and transmits the initialization signal to said reaction point at the initialization timing.

9. The congestion control system according to claim 7, wherein said initialization control section is provided for each of said plurality of reaction points, and manages the initialization timing of a corresponding one of said plurality of reaction points, and transmits the initialization signal to the one of said plurality of reaction points corresponding to the initialization timing.

10. A communication unit comprising:
at least one reaction point configured to transmit a packet to a transmission destination and to control a target rate based on a reception situation of a feedback message,
wherein when a congestion point which receives a packet transmitted from said reaction point detects congestion in itself and samples the received packet based on a predetermined algorithm, the feedback message is transmitted to said reaction point as a transmission source of the sampled packet, and
wherein said reaction point sets the target rate to an initial value at an initialization timing which does not depend on the feedback message.

11. A congestion control method comprising:
sampling a received packet based on a predetermined algorithm and transmitting a feedback message to a transmission source of the packet, when detecting congestion;
controlling a target rate based on a reception situation of the feedback message; and
setting the target rate to an initial value at an initialization timing which does not depend on the feedback message.

12. A non-transitory computer-readable recording medium in which a computer-executable communication unit control program is stored,
wherein an external communication unit samples a received packet based on a predetermined algorithm, when detecting congestion in itself, and transmits a feedback message to a transmission source of the sampled packet, and
wherein said communication unit control program makes a computer of a communication unit function as:
transmitting means for transmitting the packet to an external communication unit;
control means for controlling a target rate based on a reception situation of the feedback message; and
initializing means for setting the target rate to an initial value at an initialization timing which does not depend on the feedback message.

13. The congestion control system according to claim 2, wherein the initial value comprises a maximum transmission rate.

14. The congestion control system according to claim 2, wherein the initialization timing is different among said plurality of reaction points.

15. The congestion control system according to claim 3, wherein the initialization timing is different among said plurality of reaction points.

16. The congestion control system according to claim 2, wherein an interval between the initialization timings is different among said plurality of reaction points.

17. The congestion control system according to claim 3, wherein an interval between the initialization timings is different among said plurality of reaction points.

18. The congestion control system according to claim 4, wherein an interval between the initialization timings is different among said plurality of reaction points.

19. The congestion control system according to claim 2, wherein the interval of the initialization timings is not predetermined.

20. The congestion control system according to claim 3, wherein the interval of the initialization timings is not predetermined.
